(19) United States
(12) Patent Application Publication
(10) Pub. No.: US 2019/0026792 A1
(43) Pub. Date: Jan. 24, 2019

(54) APPARATUS AND METHOD FOR PROVIDING CUSTOMER ASSISTANCE

(71) Applicant: General Electric Company, Schenectady, NY (US)

(72) Inventors: James Alcombright, Houston, TX (US); Adam S. Guenther, San Ramon, CA (US); Krista Marie Dobis, Schenectady, NY (US); Ivan Bueno, San Ramon, CA (US)

(21) Appl. No.: 15/654,824

(22) Filed: Jul. 20, 2017

(51) Int. Cl. G06Q 30/02; G06Q 10/06

(52) U.S. Cl. CPC G06Q 30/0281; G06Q 10/0637; G06Q 10/06315; G06Q 10/06

(57) ABSTRACT

A customer identifier is scanned using an electronic scanner at the customer service center. Based upon the scanned customer identifier, service information concerning the customer is retrieved from a database at a central processing center, and presented to a technician in order to allow the technician to assist the customer. A customer problem description is obtained from the customer. The customer problem description defines a problem of the customer in need of resolution. Upon receiving an electronic indication closing the case, at the central processing center automatically updates one or more analytics or metrics that are associated with the customer service center.

### BACKGROUND OF THE INVENTION

### Field of the Invention

The subject matter disclosed herein generally relates to servicing customer problems and, more specifically, to automatically and seamlessly servicing customer problems and enhancing the customer experience at a customer service center.

### Brief Description of the Related Art

Various types of customer service centers exist. A large staff of personnel is typically required to manually service most aspects of a customer's visit to the service center. For instance, a customer may bring an electronic device to a service center for repair. A receptionist may note that the customer has arrived, add the customer to a wait list, and then the customer waits until they are called upon by a technician. The technician then examines the electronic device, and attempts to discover and fix the problem.

Unfortunately, the intensive manual nature of the actions occurring in today's customer service centers creates various problems. For instance, the manual collection of data is often so slow as to make the data stale after a short time. Stale data negatively impacts actions that might improve the customer's experience at the service center, since the actions are using outdated data. Service also is slowed and any improvements to service are based upon the feelings and emotions of those involved.

### BRIEF DESCRIPTION OF THE INVENTION

The present invention is directed to the automation of customer interactions at any type of customer service center or customer “lounge.” Once the customer problem or request is entered (either manually or obtained automatically), the present approaches automatically and seamlessly act to service the problem, take actions to enhance the customer experience, and collect information to fine-tune the operation of the service center.

In these regards, customer identification data is collected automatically by an electronic scanner, and data concerning the customer is automatically retrieved to aid in providing customer service. This customer identification data is also used in real time (or near real time) to automatically provide updated analytics and metrics, drive staffing surges at the service center, determine customer problems, provide notification of outages, receive customer feedback (that drives service improvements), and utilize artificial intelligence (AI) approaches that provide solutions to customer problems. A single interface may be used to obtain a customer's request or problem, and various interfaces may render various types of information to the customer and/or service personnel.

The present approaches automate customer interactions at the service center to provide a seamless, globally consistent customer experience that is focused on service excellence. Lounge metrics are provided to drive information technology (IT) service personnel performance and behaviors. The present approaches provide the ability to flexibly staff service centers based on customer volumes and service times. These approaches allow for the creation of a self-governing community across the globe by using gamification for rewards and de-merits.

In many of these embodiments, a customer identifier is scanned using an electronic scanner at the customer service center. Based upon the scanned customer identifier, service information concerning the customer is retrieved from a database at a central processing center, and presented at a first user interface at the customer service center to a technician to allow the technician to assist the customer.

A customer problem description is obtained from the customer. The customer problem description defines a problem of the customer in need of resolution. A solution for the customer problem is also determined. At the first user interface, a customer case that is associated with the customer problem and the solution is initiated. After a resolution to the customer case is determined, an electronic indication to close the case is received at the central processing center. Upon receiving the electronic indication closing the case, at the central processing center automatically updates one or more analytics or metrics that are associated with the customer service center. The updating utilizes or accounts for one or more of: the customer problem, the solution to the customer problem, and feedback received from the customer. The updated analytics or metrics are rendered at a second user interface. The rendering aids in taking an action to improve customer service at the customer service center.

In aspects, the action to improve a customer experience at the customer service center is based at least in part upon a human review of the updated analytics or metrics.

In other examples, a wait time and a service time to resolve the customer problem are calculated. The wait time and the service time are rendered on a third user interface to the customer. In examples, a surge response is instituted when the wait time exceeds a predetermined wait time threshold. The surge response is effective to locate and instruct resources to be used in the customer service center in solving problems of customers.

In still other examples, the solution to the problem is automatically identified based at least in part upon historic data stored in the database. In other aspects, the customer identifier is contained on or at an employee badge or a fob.

In yet other examples, at least one of the first user interface and the second user interface are mobile devices. In other examples, the customer information contains information such as an image of the customer, information identifying how many visits the customer made to the service center within a predetermined time period, or demographic information concerning the customer. Other examples are possible.

In still other aspects, the second user interface is only accessible to a supervisor or manager of the customer service center. In yet other aspects, the action may include initiating a training class, changing a product design, or electronically reporting a product problem to a manufacturer. Other examples are possible.

In others of these embodiments, a system that is configured to assist a customer in solving a problem at a customer service center includes an electronic scanner, a network, a database, a first user interface, a second user interface, and a control circuit. The electronic scanner is configured to scan a customer identifier at a customer service center. The network is coupled to the electronic scanner.

The first user interface, second user interface, and control circuit are coupled to the network. The first user interface is deployed at the customer service center and the control circuit is deployed at a central processing center.

The database is coupled to the control circuit and is deployed at the central processing center. The control circuit is configured to, based upon the scanned customer identifier, retrieve from the database service information concerning the customer. The control circuit is further configured to present the retrieved service information to a technician at the first user interface via the network. A customer problem description is obtained from the customer and entered at the first user interface. The customer problem description defines a problem of the customer that needs resolution.

A solution for the customer problem is determined. At the first user interface, a customer case is initiated, and the customer case is associated with the customer problem and the solution. An electronic indication is subsequently received by the control circuit that indicates the case is closed. Upon receiving the electronic indication, the control circuit is configured to automatically cause an update of one or more of analytics or metrics that are associated with the customer service center.

The updated analytics or metrics utilize or account for one or more of: the customer problem, the solution to the customer problem, and feedback received from the customer. The control circuit is configured to render the updated analytics or metrics at a second user interface to facilitate an action being taken to improve a customer experience at the customer service center.

In aspects, the control circuit is further configured to calculate a wait time and a service time to resolve the customer problem, and to render the wait time and the service time at a third user interface to the customer. In other aspects, the control circuit is further configured to institute a surge response when the wait time exceeds a threshold. The surge response is effective to locate and instruct resources to be used in the customer service center to solve problems of customers.

In other examples, the solution to the problem is automatically identified by the control circuit based at least in part upon historic data stored in the database. In yet other examples, the customer identifier is contained on or at an employee badge or a fob.

In other aspects, at least one of the first user interface, and the second user interface are mobile devices.

The customer information may include an image of the customer, information identifying how many visits the customer made to the service center within a predetermined time period, or demographic information concerning the customer. Other examples are possible.

In still other examples, the second user interface is only accessible to a supervisor or manager of the customer service center. In yet other examples, the action may include initiating a training class, changing a product design, or electronically reporting a product problem to a manufacturer. Other examples are possible.

### BRIEF DESCRIPTION OF THE DRAWINGS

For a more complete understanding of the disclosure, reference should be made to the following detailed description and accompanying drawings wherein:

FIG. 1 comprises a block diagram of a system including a service center according to various embodiments of the present invention;

FIG. 2 comprises a block diagram showing the operations of a customer service center according to various embodiments of the present invention;

FIG. 3 comprises a block diagram showing the functional processing elements at a control circuit according to various embodiments of the present invention;

FIG. 4 comprises a flowchart of one approach of retrieving customer information according to various embodiments of the present invention;

FIG. 5 comprises a flowchart of one approach for updating analytics and metrics according to various embodiments of the present invention;

FIG. 6 comprises a flowchart of one approach for determining a wait time according to various embodiments of the present invention;

FIG. 7 comprises a flowchart an approach for determining a service time according to various embodiments of the present invention;

FIG. 8 comprises a flowchart of an approach for instituting a surge according to various embodiments of the present invention;

FIG. 9 comprises a flowchart of one example of an approach for gamification of system interactions according to various embodiments of the present invention;

FIG. 10 comprises a flowchart of one example of an approach for addressing customer feedback according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the present approaches, a customer service center or customer “lounge” is provided. Customer identification data is collected automatically by an electronic scanner at the service center and data concerning the customer is automatically retrieved. Among other things, the customer identification data is used in real time (or near real time) to provide service to the customer. Updated analytics and metrics are provided, staffing surges at the service center are enabled, customer problems are determined, notification of outages is provided, and customer feedback is received.

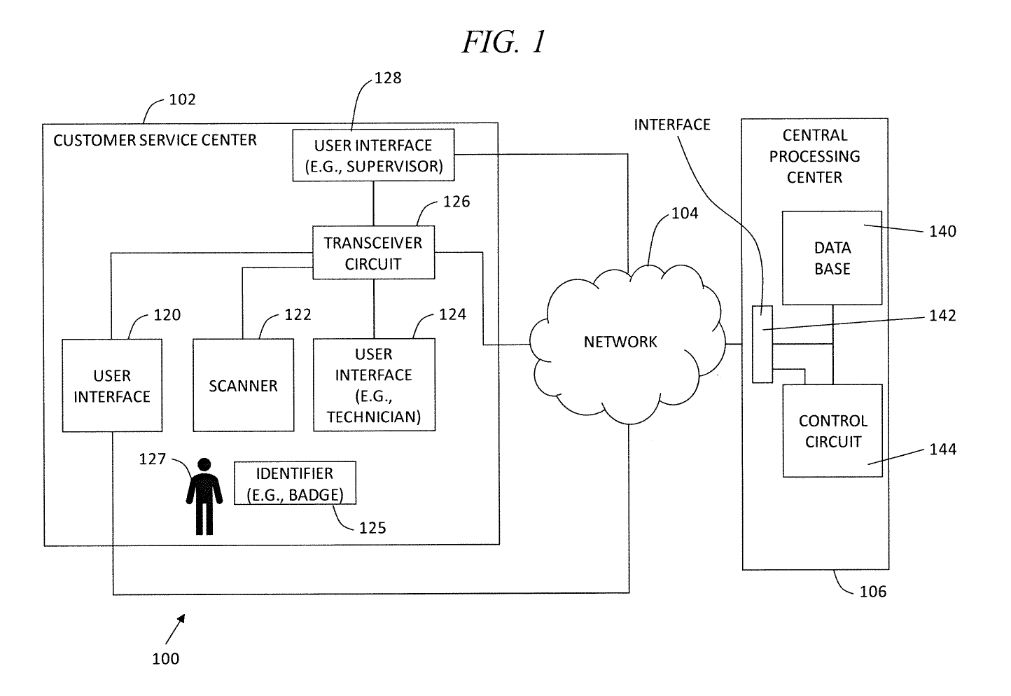

Referring now to FIG. 1, one example of a system 100 for servicing customer service issues and problems is described. The system 100 includes a customer service center 102, a network 104, and a central processing center 106. The customer service center 102 includes a first user interface 120, a scanner 122, a second user interface 124, a transceiver circuit 126, and a third user interface 128. The central processing center 106 includes a database 140, an interface 142, and a control circuit 144.

The customer service center 102 is any type of customer center where customer problems are processed or handled. In one example, the customer service center 102 is a place where customers can bring an electronic device or other consumer device for repair. In yet other examples, the service center 102 is a vehicle service center. In still other examples, the service center 102 is a place where the customer need not bring any product or device, but simply visits to seek or receive advice or services. For instance, the service center 102 may provide medical, dental, legal, tax, or business services.

The network 104 is any type of network or combination of networks such as a cloud network or the internet. It may include devices such as routers, gateways, and processors.

The central processing center 106 is disposed at a location that is remote from the customer service center 102, i.e., at a different physical location than the customer service center 102.

As mentioned, the customer service center 102 includes a first user interface 120, a scanner 122, a second user interface 124, a transceiver circuit 126, and a third user interface 128.

The first user interface 120, second user interface 124, and third user interface 128 are any type of electronic devices that allow information to be entered and/or displayed to users. In examples, the first user interface 120, second user interface 124, and third user interface 128 may be personal computers, laptops, tablets, cellular phones, or personal digital assistants. Other examples are possible.

The scanner 124 is an electronic device that is configured to read or scan an identifier 125 of a person 127 and obtain identification information. In one example, the scanner 124 scans bar code information. Other examples of scanners are possible.

The transceiver circuit 126 is any type of device that can transmit information to or receive information from the network 104. In examples, the transceiver circuit 126 may include any combination of hardware circuitry and computer software that performs these functions.

As mentioned, the central processing center 106 includes a database 140, an interface 142, and a control circuit 144. The database 140 is any type of memory storage device or combination of memory storage devices. The database 140 may store various types of information about the consumer. This information can be stored in various types of data structures such as tables, linked lists, or other structures or combination of structures.

The interface 142 is any type of device that can transmit information to or receive information from the network 104. In examples, the interface 142 contains electronic hardware and/or software that performs these functions.

The control circuit 144 processes different types of information and may issue instructions to the customer service center 102. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 144 may be configured (for example, by using corresponding programming stored in a memory as will be well understood by those skilled in the art) to carry out one or more of the steps, actions, and/or functions described herein.

In one example of the operation of the system 100 of FIG. 1, a customer identifier (e.g., on a badge) is scanned using an electronic scanner at the customer service center 102. Based upon the scanned customer identifier, service information concerning the customer 127 is retrieved from the database 140 at the central processing center 106, and presented at the first user interface 124 at the customer service center 102 to a technician to allow the technician to assist the customer 127.

A customer problem description is obtained from the customer 127. The customer problem description defines a problem of the customer in need of resolution. The problem description may be manually obtained (e.g., by listening to the customer describe the problem), or the problem description may be automatically obtained (e.g., an electronic device that is the source of the problem may have problem “codes” that are automatically scanned or obtained). A solution for the customer problem is also determined. The solution may be obtained from an AI apparatus that proposes a solution based upon previous similar type problems. At the first user interface 124, a customer case (that is associated with the customer problem and actions that solve the problem) is initiated.

After a resolution to the customer case is determined, an electronic indication to close the case is sent to and received at the central processing center 106. A technician, for example, may manually close the case at the service center by entering a “case closed” indication into an interface. Upon receiving the electronic indication closing the case, at the central processing center 106, analytics or metrics that are associated with the customer service center 102 are automatically updated. The updating utilizes or accounts for one or more of: the customer problem, the solution to the customer problem, and feedback received from the customer. The updated analytics or metrics are rendered at a second user interface 128. The rendering aids in taking an action to improve customer service in the customer service center 102.

In aspects, the action to improve a customer experience at the customer service center 102 is based at least in part upon a human review of the updated analytics or metrics at the interface 128.

In other examples, a wait time and a service time to resolve the customer problem are calculated at the control circuit 144. The wait time and the service time are rendered on a third user interface 120 to the customer. In examples, a surge response is instituted when the wait time exceeds a predetermined wait time threshold. The surge response is effective to locate and instruct resources to be used in the customer service center to solve problems of customers.

In still other examples, the solution to the problem is automatically identified based at least in part upon historic data stored in the database 140. In other aspects, the customer identifier is contained on or at an employee badge or a fob.

In yet other examples, at least one of the first user interface 124 and the second user interface 127 are mobile devices. In other examples, the customer information contains information such as an image of the customer, information that identifies how many visits the customer made to the service center within a predetermined time period, or demographic information concerning the customer. Other examples are possible.

In other aspects, the second user interface 127 is only accessible to a supervisor or manager of the customer service center. In yet other aspects, the action may include initiating a training class, changing a product design, or electronically reporting a product problem to a manufacturer. Other examples are possible.

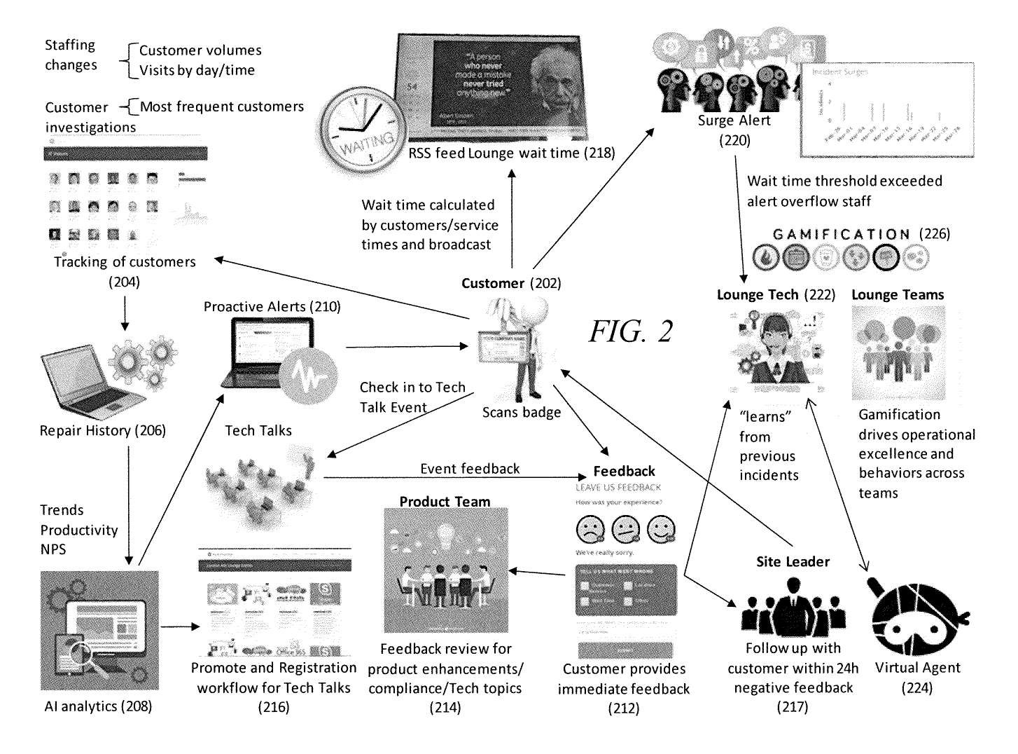

Referring now to FIG. 2, one example of the operations of a customer service center is described. A customer 202 has their badge (or other identifier) scanned. The badge includes information (e.g., a bar code) that identifies the customer.

Tracking of customers occurs at step 204. More specifically, the activities of the customer may be automatically tracked using the information that identifies the customer. The tracking may include customer investigations that identify the most frequent customers, or may relate staffing changes to customer volume and customer visits (e.g., by day and/or time). Other examples are possible.

The repair history of a customer product may be analyzed at step 206 and artificial intelligence (AI) analytics executed at step 208. The AI analytics may utilize or account for the customer problem, the solution to the customer problem, and/or feedback received from the customer. At step 210, proactive alerts may be issued. For example, if the analytics or other information indicate that the customer's product will likely fail in the future (but has not failed as of yet), steps can be taken to prevent a future failure or alert the customer of the predicted future failure.

At step 212, feedback is provided to the service center. In examples, feedback may be entered in to an electronic interface by a customer. At step 214, the feedback is reviewed for product enhancements, compliance with rules, or other technical issues or topics. The review may be a manual review or an automatic and electronic review. At step 216, technical talks, meetings, or seminars can be organized including sending registration materials for the customers. At step 217, negative feedback can be addressed by a site leader (e.g., the site leader addresses negative feedback within 24 hours).

At step 218, wait times and service time for customers are automatically calculated and displayed for customers. For example, these times can be displayed at large screens in the customer service area or sent to a user's personal electronic device.

At step 220, a surge alert may be initiated when a wait time threshold is exceeded. For example, if the wait time exceeds 30 minutes, then a surge alert is initiated. In this case, additional staff may be instructed to report to the service center. In other examples, existing staff may have their tasks re-allocated within the service center. The goal of taking these actions is to reduce the wait time and improve the customer experience.

At step 222, a technician may report information to a virtual agent 224 that involves how a problem was fixed or resolved. The virtual agent 224 may be a computer program that is configured to learn this information. For example, the virtual agent may analyze and categorize customer problems. The solutions of these problems are also tracked by the virtual agent. Thus, a given problem type may be used as an index in a database to one or more possible solutions. A service technician may utilize this information to resolve the problem. In other words, the virtual agent 224 learns from previous incidents to provide possible solutions to customer problems.

At step 224, gamification approaches are utilized. For example, if a service technician resolves a problem in a satisfactory way, then that technician can earn rewards. In one specific example, the technicians can earn points that can redeemed for cash, products, and/or services. Gamification drives operational excellence and behaviors across employee teams. The gamification approaches can be deployed not only at the service center, but across multiple service centers and across all geographic areas. It will also be realized that penalties and de-merits can be assigned based upon performance.

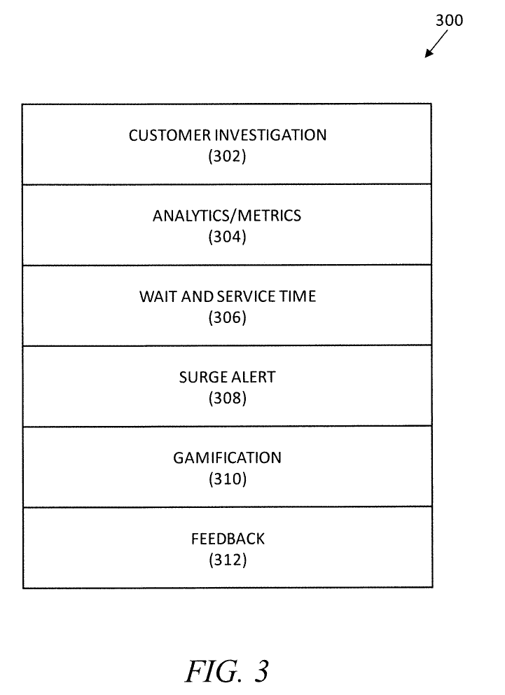

Referring now to FIG. 3, one example of an organization and content of software routines or computer programs executed at a control circuit (e.g., the control circuit 144 of FIG. 1) is described. In this example, software routines 300 include customer investigation programs 302, analytics and metrics programs 304, wait and service time programs 306, surge alert programs 308, gamification programs 310, and feedback programs 312. By “programs” or “routines,” it is meant computer instructions that are executed at a hardware component such as a microprocessor.

The customer investigation programs 302 retrieve from a database at a central processing location service information concerning the customer, and present the retrieved service information to a technician to allow the technician to assist the customer. For example, the number of customer visits, and the previous repair history of a customer may be retrieved. A technician may utilize this information to better service the customer. For instance, if the technician is aware of the previous service information concerning the customer, the technician may have a head start in resolving the problem of the customer.

The analytics and metrics programs 304 update one or more analytics or metrics that are associated with the customer service center. The updated analytics or metrics utilize (or account for) one or more of the customer problem, the solution to the customer problem, or feedback received from the customer. Metrics may include performance measurement information such as average wait or service times.

The wait and service time programs 306 calculate a wait time and a service time to resolve the customer problem. In aspects, these programs also render or present the wait time and the service time on displays to the customer.

The surge alert programs 308 examine the wait time, and if the wait time exceeds a threshold, request additional resources at the service center. The additional resources may include addition technician, additional other personnel, addition physical resources (e.g., additional computer hardware or software), or additional funding to mention a few examples.

The gamification programs 310 may examine customer feedback and other performance indicators of technicians (or others that work in or are associated with the customer service center) in resolving the customer problems. After an evaluation of the performance, rewards for performance may be issued. For example, rewards may be issued for technicians that service more than a threshold number of customers in a satisfactory manner during a given time period. The gamification programs 310 may also issue penalties or other de-merits for unsatisfactory performance. For example, the gamification programs 310 may electronically reduce the salary of an employee for unsatisfactory performance. Other examples are possible.

The feedback programs 312 receive feedback from customers and process that feedback. For example, feedback may be categorized and actions taken. Actions may include holding training sessions (or other information sessions) for customers, or issuing instructions to have supervisors (or others) address negative customer feedback.

In the case of negative feedback, a supervisor may be automatically and electronically presented with a list of negative feedback from various customers on a viewing screen, and the supervisor may scroll through the screen, contacting the customer (e.g., whose phone number is on the screen) by phone to address the feedback. Automatically generated emails can also be used to contact the customer.

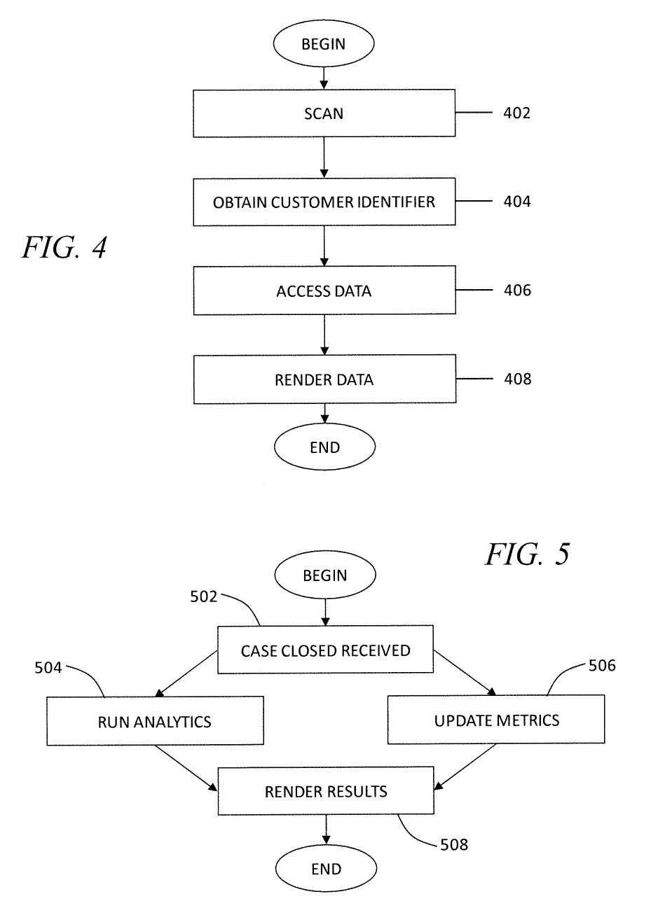

Referring now to FIG. 4, an approach for obtaining customer information is described. At step 402, a scan is made of a customer identification object or element. For example, the customer may have a badge that is scanned by a scanner.

At step 404, a customer identifier is obtained from the scan. For example, a barcode that is scanned, and the barcode may be associated with the name and other identification information associated with a particular customer.

At step 406, the customer identifier is used to retrieve data associated with the customer. For example, the customer identifier may be used as an index to a data structure in a database to retrieve information (e.g., including the service history of the customer) that is associated with the customer identifier.

At step 408, the retrieved information is rendered or presented to a technician. For example, the retrieved information may be rendered on a screen to a technician. The information may be used by the technician to better service the customer.

Referring now to FIG. 5, one example of an approach for updating metrics and analytic programs is described. In aspects, the analytics or metrics relate to the service center, and may relate to, calculate, or be utilized in calculations that obtain the average daily use of the service center, the mean or median wait and service times at the service center, or the efficiencies of particular technicians in the service center. Other examples are possible.

At step 502, an indication that a customer service case has been closed is received. The indication may be an electronic message and is a trigger. In one example, the indication that the case is closed is entered by the technician that serviced the customer, and this causes an electronic message to be created.

At step 504, updated analytics are executed. The analytics may be computer programs that calculate different values (e.g., mean or median wait times). At step 506, updated metrics may also be determined. For example, the number of people who visited the service center on a certain day may be a computer variable, and with this step, this variable may be incremented.

At step 508, the updated metrics and analytics (or the results of executing programs that determine these values) may be rendered to authorized employees or others. For example, supervisors of the customer service center may be authorized to review the results on a graphical display (e.g., at a personal computer, laptop, tablet, or cellular phone). These results may be utilized to optimize the performance of the customer service center.

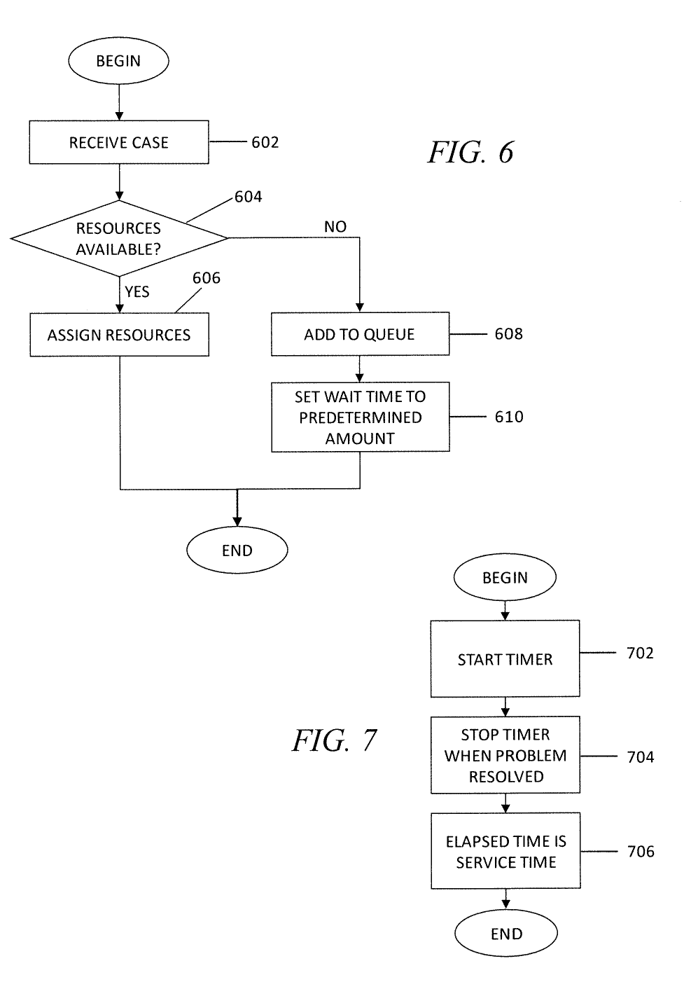

Referring now to FIG. 6, one example of an approach for determining a wait time is described. At step 602, an indication that a particular case has been instigated at the service center is received. In aspects, the indication includes an identification of the case, an identification of the customer associated with the case, information concerning the customer (e.g., address or previous service history), the type of problem involved in the case, and a solution to this problem.

At step 604, it is determined whether resources available to work on or address the case. In one example, the resources include service technicians, computer resources, or spare parts to mention a few examples. In aspects, a computer variable that represents resources that are available is maintained. If this variable is greater than zero, then resources are available.

To take one example, the number of technicians available may be the only resource. If the service center is staffed with 10 technicians, then a variable called “Number of technicians” is initially set to 10 (e.g., at the beginning of the day). With every instance of a new case, a technician is assigned and the “Number of technicians” variable is decremented. When “Number of technicians” reaches 0, then a wait time is calculated. When a technician finishes a case, the variable is incremented.

If the answer at step 604 is affirmative, at step 606 resources are assigned. For example, a service technician is assigned to service the case. In other examples, computer or other physical resources are assigned to resolve the case.

If the answer at step 604 is negative, at step 608 the case is added to a queue. The queue, in some aspects, may be a first-in-first out buffer.

At step 610, a wait time may be set to a predetermined amount. For example, each place in the queue may be assigned a predetermined time amount. When a case is placed at the position in the queue, the case may be assigned that wait time. In one specific example, if a case is assigned to be first in the queue, a 15-minute wait time may be set. If the case is assigned to the second place in the queue, a 30-minute wait time. In aspects, the changing wait time is implemented with an active timer that counts down to zero as the case is in and moves through the queue.

The wait time may be adjusted or reset while the case is in the queue. For example, if an unexpected event occurs (e.g., that will increase the wait time) or if the timer for a place in the queue goes to 0 without the case being serviced, then 15 minutes may be added to all cases in the queue. Other examples are possible.

Referring now to FIG. 7, one example of an approach for determining a service time is described. At step 702 a timer is started. The timer is started when service is started and may, in examples, be when the case is initially assigned or when the technician actually begins work on the case. Once started, the service time timer decrements to 0 as time passes.

At step 704, the timer is stopped when the problem or case is resolved. The timer may be halted by the technician entering an indication that the case is resolved into a user interface. At step 706, the elapsed time of the timer becomes the service time.

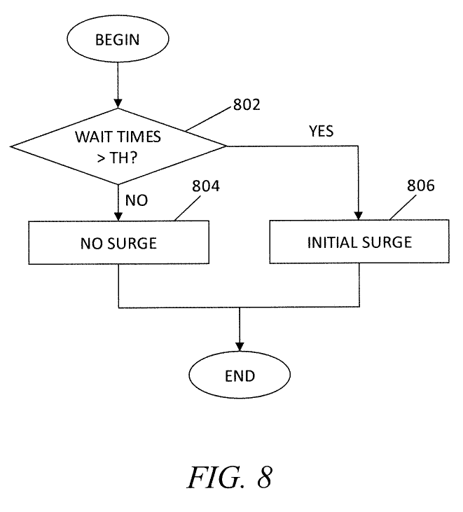

Referring now to FIG. 8, one example of an approach of instituting a surge is described. As used herein, “surge” refers to adding resources to the service center when a predetermined event occurs (e.g., when the wait or service time exceeds a predetermined threshold).

At step 802, it is determined if the wait time is greater than a predetermined threshold (TH). If the answer is negative, execution continues at step 804 where no surge action is taken. If the answer is affirmative, at step 806, a surge is instituted. Actions instituted by the surge may include adding personnel to the service center, or adding other resources to the service center. In aspects, email messages may be automatically sent to personnel instructing the personnel to report to the service center.

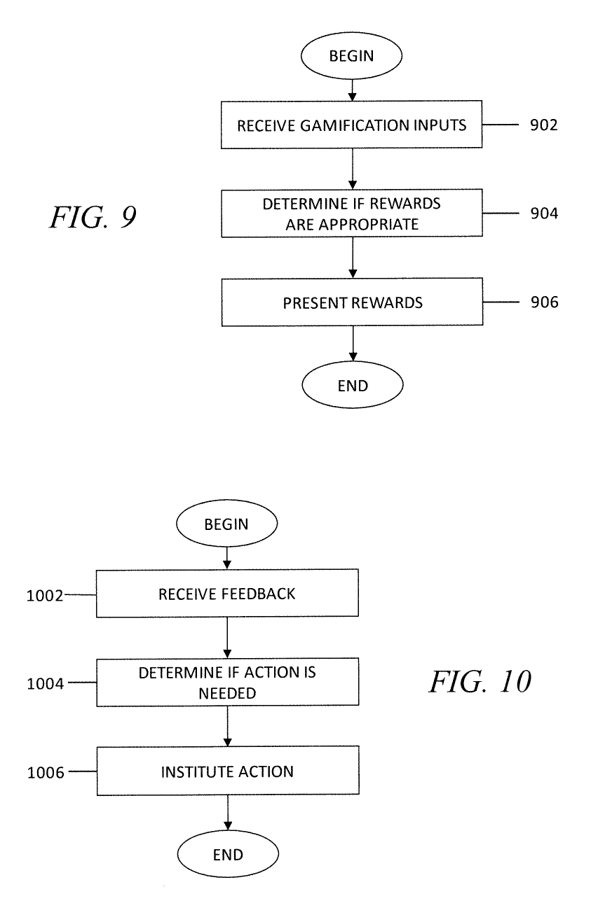

Referring now to FIG. 9, one example of an approach for gamification is described. At step 902, gamification inputs are received. These may include the identity of a customer service representative or technicians, feedback scores for that representative or technician, success rates for the representative or technicians at completing tasks, or the number of cases handled on a particular date or time period by service personnel.

At step 904, it is determined whether rewards for the employee are appropriate. For example, points may be awarded to the employee for good, satisfactory, or exemplary behavior, and when the points exceed a predetermined threshold, a reward is determined. The rewards may be a cash reward, a recognition, or some other action.

At step 906, the rewards are presented to the employee. For example, the employee may have a reward indication applied to their employee identification badge. In other examples, the employee's salary may be increased. In other examples, points may be awarded that may be redeemed for cash or merchandise. Other examples are possible.

Gamification can occur across just the service center (e.g., for only employees of the service center), but can also occur over a wider spectrum. For example, employees of the service center may compete for rewards world-wide, and across multiple service centers to mention one example. In this example, only after competing and ranking high enough in the competition will rewards be received by the employee. To take one specific example, a competition or “game” may be initiated that challenges employees to service the most number of cases in one day and this competition occurs world-wide across multiple service centers. However, awards are only given to the top three employees.

Referring now to FIG. 10, one example of a feedback approach useful in a service center is described. At step 1002, feedback is received from customers. The feedback may be electronic feedback solicited from surveys or may be unsolicited feedback received from the customer. In examples, customers may enter feedback on electronic devices such as their cellular phones or tablets.

At step 1004, a determination is made as to whether an action (immediate or future action) is needed to address the feedback. For example, certain classes of feedback (e.g., those involving potential criminal activity) may require an immediate action. The nature of the action may also be determined. For example, the action may be the sending of an email to a supervisor to investigate a problem. In some case, electronic instructions may be sent to the customer service center to cause actions to occur (e.g., close doors, open doors, turn on monitors, or turn on an air conditioner). These actions address customer feedback that is received.

At step 1006, the action is instituted. In one example, the supervisor may take steps to address negative feedback.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method of assisting a customer in solving a problem at a customer service center, the method comprising:
scanning a customer identifier using an electronic scanner at the customer service center;
based upon the scanned customer identifier, retrieving from a database at a central processing center service information concerning the customer, and presenting the retrieved service information at a first user interface at the customer service center to a technician in order to allow the technician to assist the customer;
obtaining a customer problem description from the customer, the customer problem description defining a problem of the customer in need of resolution, and determining a solution for the customer problem;
at the first user interface, initiating a customer case that is associated with the customer problem and the solution;
after a resolution to the customer case is determined, receiving an electronic indication to close the case at the central processing center;
upon receiving the electronic indication closing the case, at the central processing center automatically updating one or more analytics or metrics that are associated with the customer service center, wherein the updating utilizes or accounts for one or more of: the customer problem, the solution to the customer problem, and feedback received from the customer;
rendering the updated analytics or metrics at a second user interface, the rendering aiding in taking an action to improve customer service in the customer service center.

2. The method of claim 1, further comprising taking the action to improve a customer experience at the customer service center based at least in part upon a human review of the updated analytics or metrics.

3. The method of claim 1, further comprising calculating a wait time and a service time to resolve the customer problem, and rendering the wait time and the service time on a third user interface to the customer.

4. The method of claim 3, further comprising instituting a surge response when the wait time exceeds a predetermined wait time threshold, the surge response being effective to locate and instruct resources to be used in the customer service center to solve problems of customers.

5. The method of claim 1, wherein the solution to the problem is automatically identified based at least in part upon historic data stored in the database.

6. The method of claim 1, wherein the customer identifier is contained on or at an employee badge or a fob.

7. The method of claim 1, wherein at least one of the first user interface and the second user interface are mobile devices.

8. The method of claim 1, wherein the customer information contains information selected from the group consisting of: an image of the customer, information identifying how many visits the customer made to the service center within a predetermined time period, and demographic information concerning the customer.

9. The method of claim 1, wherein the second user interface is only accessible to a supervisor or manager of the customer service center.

10. The method of claim 1, wherein the action is an action selected from the group consisting of: initiating a training class, changing a product design, and electronically reporting a product problem to a manufacturer.

11. A system that is configured to assist a customer in solving a problem at a customer service center, the system comprising:
an electronic scanner that is configured to scan a customer identifier at a customer service center;
a network coupled to the electronic scanner;
a first user interface, a second user interface, and a control circuit coupled to the network, wherein the first user interface is deployed at the customer service center and the control circuit is deployed at a central processing center;
a database coupled to the control circuit, the database being deployed at the central processing center;
wherein the control circuit is configured to, based upon the scanned customer identifier, retrieve from the database service information concerning the customer, the control circuit further configured to present the retrieved service information to a technician at the first user interface via the network;
wherein a customer problem description is obtained from the customer and entered at the first user interface, the customer problem description defining a problem of the customer that is in need of resolution;
wherein a solution for the customer problem is determined;
wherein at the first user interface, a customer case is initiated, the customer case being associated with the customer problem and the solution;
wherein an electronic indication is subsequently received by the control circuit that indicates the case is closed, and upon receiving the electronic indication, the control circuit is configured to automatically cause updating of one or more of analytics or metrics that are associated with the customer service center, wherein the updated analytics or metrics utilize or account for one or more of: the customer problem, the solution to the customer problem, and feedback received from the customer and wherein the control circuit is configured to render the updated analytics or metrics at a second user interface in order to facilitate an action being taken to improve a customer experience at the customer service center.

12. The system of claim 11, wherein the control circuit is further configured to calculate a wait time and a service time to resolve the customer problem, and to render the wait time and the service time at a third user interface to the customer.

13. The system of claim 12, wherein the control circuit is further configured to institute a surge response when the wait time exceeds a threshold, the surge response being effective to locate and instruct resources to be used in the customer service center to solve problems of customers.

14. The system of claim 11, wherein the solution to the problem is automatically identified by the control circuit based at least in part upon historic data stored in the database.

15. The system of claim 11, wherein the customer identifier is contained on or at an employee badge or a fob.

16. The system of claim 11, wherein at least one of the first user interface, and the second user interface are mobile devices.

17. The system of claim 11, wherein the customer information contains information selected from the group consisting of: an image of the customer, information identifying how many visits the customer made to the service center within a predetermined time period, and demographic information concerning the customer.

18. The system of claim 11, wherein the second user interface is only accessible to a supervisor or manager of the customer service center.

19. The system of claim 11, wherein the action is an action selected from the group consisting of: initiating a training class, changing a product design, and electronically reporting a product problem to a manufacturer.
